(19) United States
(12) Patent Application Publication
(10) Pub. No.: US 2016/0121573 A1
(43) Pub. Date: May 5, 2016

(54) Method of Manufacturing An Advertising Format

(71) Applicant: Suncraft Technologies, Inc., Naperville, IL (US)

(72) Inventors: Ronald F. DeSanto, Oswego, IL (US); William E. Castillo, Bolingbrook, IL (US); Holly D. Winters, Orland Park, IL (US); Beverly R. Ziencina, Aurora, IL (US)

(21) Appl. No.: 14/994,288

(22) Filed: Jan. 13, 2016

Related U.S. Application Data
(62) Division of application No. 14/211,204, filed on Mar. 14, 2014, now abandoned.

(51) Int. Cl. B31D 5/04; G09F 1/06

(52) U.S. Cl. CPC B31D 5/04; G09F 1/06

(57) ABSTRACT

A method of manufacturing the format is described. The advertising format has a display area presented in a horizontal fashion and in a plane above the substrate, so that the display area can be seen upon first opening the format, and the same side of the display area rises toward the user upon further opening the format. The method of manufacturing the advertising format uses an in-line finishing system to create a mass-distributable packet, in a single-pass manufacturing process, using no pre-manufactured portions.

### PRIORITY

This application is a division of copending U.S. patent application Ser. No. 14/211,204, filed Mar. 14, 2014, the disclosure of which is incorporated by reference.

### FIELD OF THE INVENTION

This invention is directed to an advertising format in which a display area is presented in a horizontal position upon opening the format, and to a method of manufacturing that format. The invention is more specifically directed to an in-line finishing system for manufacturing the advertising format in a mass-distributable packet, in a single-pass manufacturing process, using no pre-manufactured portions.

### BACKGROUND OF THE INVENTION

Advertisers commonly use mass-distributable packets to promote their products. These packets are distributed by mail, by insert into newspapers or other periodicals, by hand delivery, or otherwise. Advertisers often wish to incorporate a pop-up assembly into a mass-distributable packet. A pop-up assembly will catch the reader's attention and hold that attention for a longer span than the same advertising content without a pop-up assembly. Advertisers desire a pop-up assembly that is smaller than the substrate and appears to raise the advertising content in the same plane as the substrate, without the need for a spring. Accordingly, there is a need for an advertising format in which a display area is presented in a horizontal fashion and in a plane above the substrate. The present invention provides an advertising format and a method for manufacturing that format, in which the display area can be seen upon first opening the format, and the same side of the display area rises toward the user upon further opening the format.

### SUMMARY OF THE INVENTION

The preferred embodiment of the method of the present invention comprises the steps of providing a web on a web press, the web having a first edge and a second edge and a top side and bottom side; cutting an aperture in the web; forming a display area in vertical registry with the aperture, the display area defined by a first die cut, a second die cut, a first connection portion, and a second connection portion, the first die cut being proximal to the aperture and the second die cut being distal to the aperture, each of the die cuts having a first end and a second end, the first die cut first end being separated from the second die cut first end by the first connection portion and the first die cut second end being separated from the second die cut second end by the second connection portion, the first connection portion having a width and the second connection portion having a width, the first connection portion width being the same as the second connection portion width, and the display area having a shape configured to fit completely within the aperture; forming four perforation lines in the web, the first perforation line being between the aperture and the first die cut; the second perforation line being a first partial fold line, the first partial fold line intersecting the first end of the first die cut and the second end of the first die cut and being parallel to the first edge, the first partial fold line not being formed in the display area; the third perforation line being a second partial fold line, the second partial fold line intersecting the first end of the second die cut and the second end of the second die cut and being parallel to first edge, the second partial fold line not being formed in the display area; and the fourth perforation line being spaced from the second edge of the web by a distance substantially equal to the width of the first and second connection portions; forming three fold lines in the web, the first fold line being between the aperture and the first edge of the web, the second fold line being the first fold line and the first edge of the web, and the third fold line being between the second fold line and the first edge of the web; applying an adhesive to an area of the web between the first die cut and the aperture; forming a Z-flap by folding the web at the first perforation line and the second perforation line so that the display area registers over the aperture; folding the web onto itself at the third perforation line; applying an adhesive to at least one of a first area defined by the fourth perforation line and the second edge of the web and a second area extending from first fold line toward the second fold line and spaced a distance substantially equal to the width of the first and second connection portions; folding the web onto itself at the first fold line; folding the web under itself at the second fold line; and folding the web onto itself at the third fold line.

The preferred embodiment of the article of manufacture of the present invention comprises an advertising format, comprising a substrate, the substrate comprising a first page, a second page, and a third page, the first page defined by an outer border, an upper border, a right border, and a lower border, the second page defined by a left border, an upper border, a right border, and a lower border, the third page defined by a left border, an upper border, a right border, and a lower border, the first page right border being contiguous to the second page left border at a first fold tine, and the second page right border being contiguous to the third page inner border at a second fold line; a fourth page defined by a left border, an upper border, a right border, and a lower border, the fourth page left border being contiguous to the third page right border at a third fold line; an aperture within the fourth page; a fifth page defined by a left border, an upper border, an outer border, and a lower border, the fifth page left border being contiguous to the fourth page right border at a fourth fold line, the fifth page further comprising a fifth fold line forming a tab at the fifth page outer border, the fifth page further comprising a display area, the display area defined by a first die cut and a second die cut, the first die cut being proximal to the aperture and the second die cut being distal to the aperture, each of the die cuts having a first end and a second end, the first ends of each of the die cuts being proximal to the fifth page top border and the second ends of each of the die cuts being distal to the fifth page top border, the first die cut first end being separated from the second die cut first end by a first connection portion and the first die cut second end being separated from the second die cut second end by a second connection portion, the first connection portion having a width, the second connection portion having a width, the first connection portion width being the same as the second connection portion width, and the display area having a shape configured to fit completely within the aperture; the fifth page further comprising a seal area defined by the top border, the upper border, the lower border, the fifth fold line, and the first die cut, the seal area being attached to the fourth page, the fifth page further comprising a seal tab defined by the top border, the upper border, the lower border, and the seventh fold line, the seal tab being attached to the third page.

### A BRIEF DESCRIPTION OF THE DRAWINGS

The organization and manner of the structure and operation of the invention, together with further objects and advantages thereof, may best be understood by reference to the following description, taken in connection with the accompanying non-scale drawings, wherein like reference numerals identify like elements in which:

FIG. 1 is a side view of the advertising format of the preferred embodiment of the present invention.

FIG. 2 is a perspective view of the advertising format of FIG. 1.

FIG. 3 is a plan view of an unfolded advertising format of FIG. 1.

FIG. 4 is a plan view of a partially folded advertising format of FIG. 1.

FIG. 5 is yet another plan view of a partially folded advertising format of FIG. 1.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

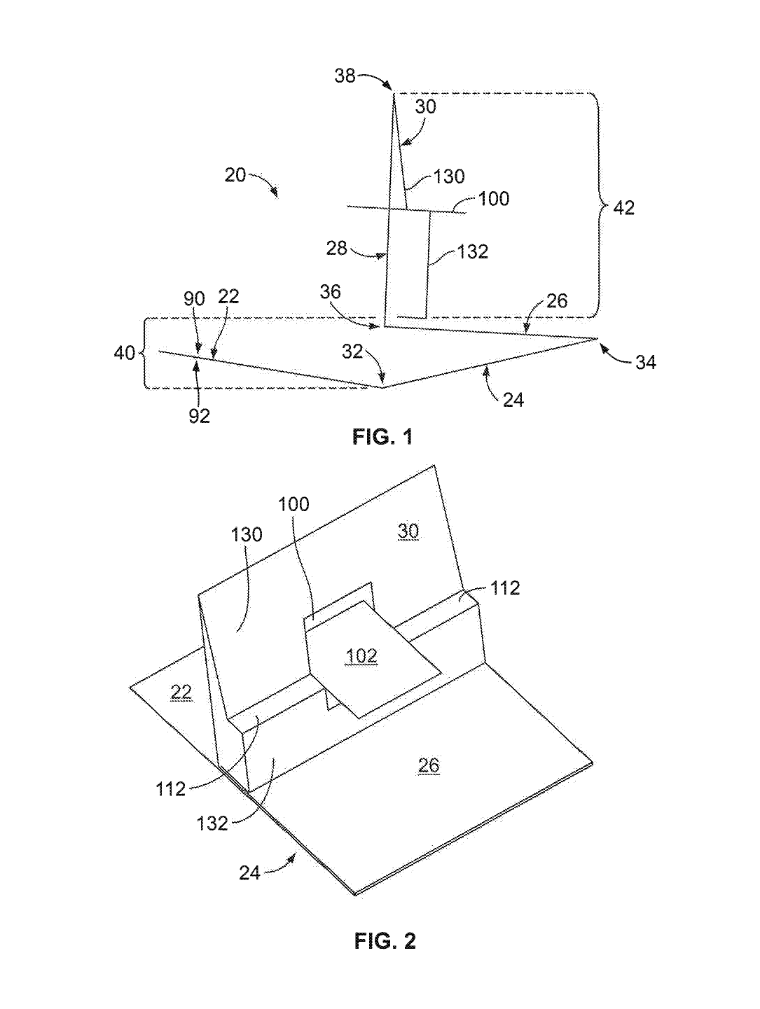

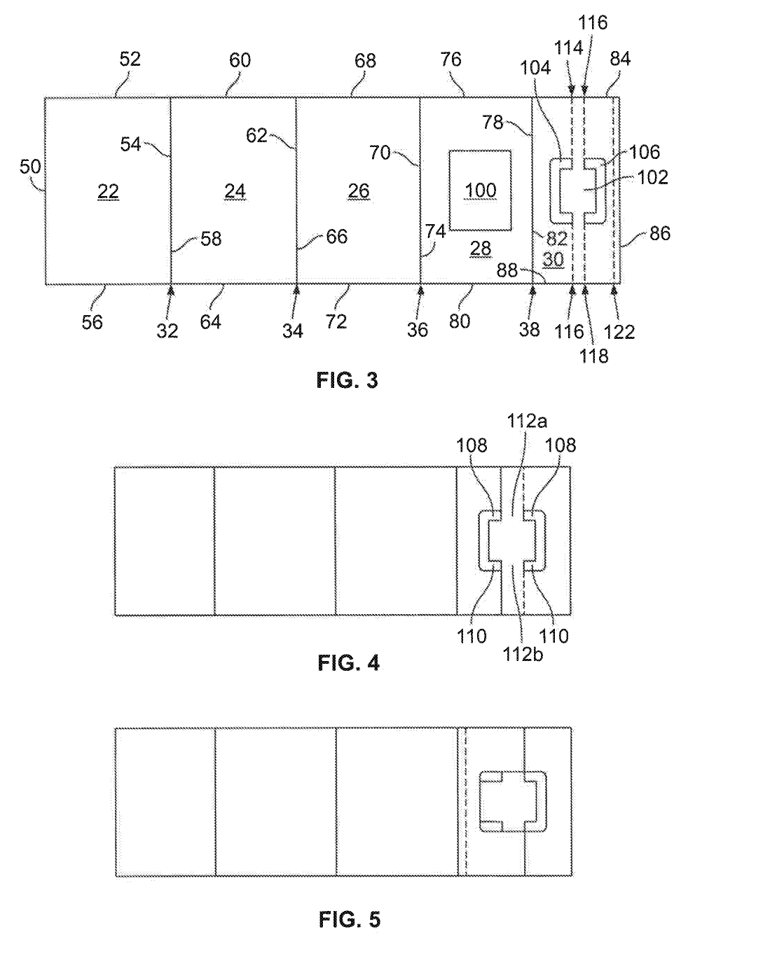

The advertising format 20 of the preferred embodiment of the present invention is shown in side view in FIG. 1, in perspective view in FIG. 2, and in plan view, in unfolded form, in FIG. 3. Format 20 is made of five connected pages 22, 24, 26, 28, and 30, connected at first fold line 32, second fold line 34, third fold line 36, and fourth fold line 38. First page 22, second page 24, and third page 26 form the substrate 40 of format 20. Fourth page 26 and fifth page 28 form the upraised portion 42 of format 20.

First page 22 is defined by an outer border 50, an upper border 52, a right border 54, and a lower border 56. Second page 24 is defined by a left border 58, contiguous with first page right border 54, an upper border 60, a right border 62, and a lower border 64. Third page 26 is defined by a left border 66, contiguous with second page right border 62, an upper border 68, a right border 70, and a lower border 72.

Fourth page 28 has a left border 74, contiguous with third page right border 68, an upper border 76, a right border 78, and a lower border 80. Fifth page 30 has a left border 82, an upper border 84, an outer border 86, and a lower border 88.

Connected pages 22, 24, 26, 28, and 30 have a first side 90 and an opposite side 92, First side 90 is preferably printed. Opposite side 92 is optionally printed.

Fourth page 28 further has an aperture 100 contained within and preferably not touching any of borders 72, 74, 76, and 78. Aperture 100 is preferably rectangular.

Fifth page 30 further has a display area 102. Display area 102 is sized and shaped to fit within aperture 100. Display area 102 is defined by a first die cut 104 and a second die cut 106. Die cut 104 is proximal to aperture 100; die cut 106 is distal to aperture 100. Each of die cuts 104, 106 are preferably in the shape of a sidewise letter U to correspond to the rectangular shape of the preferred embodiment of aperture 100, but could also be arcuate or have another shape. In the preferred embodiment, both display area 102 and aperture 100 are generally rectangular, but either or both display area 102 and aperture 100 can have different shapes, so long as display area 102 will fit into aperture 100.

Die cuts 104, 106 each have a first end 108 and a second end 110. Each first end 108 is proximal to fifth page upper border 84; each second end 110 is distal to fifth page upper border 84. First ends 108 are spaced apart by a connection portion 112a having a width. Second ends 110 are spaced apart by a connection portion 112b having the same width.

A first half-fold line 114 extends from first end 108 of die cut 104 to upper border 84, and is parallel to left border 82. A second half-fold line 116 extends from first end 108 of die cut 106 to upper border 84, is parallel to left border 82 as well, and is spaced apart from first half-fold line 114 by width 112. A third half-fold line 118 extends from second end 110 of die cut 104 to lower border 88, and is parallel to left border 82. A fourth half-fold line 120 extends from second end 110 of die cut 106 to lower border 88, is parallel to left border 82 as well, and is spaced apart from third half-fold line 118 by width 112.

A fifth fold line 122 is spaced apart from outer border 86 by a width 124 to define tab 126. Width 124 is preferably less than or equal to width 112.

In the preferred embodiment, the width of first page 22, as measured from outer border 50 to right border 54, is the same as the width of second page 24, as measured from left border 58 to right border 62, The width of third page 26, as measured from left border 66 to right border 70, is slightly less than the width of first page 22 and second page 24. The width of fourth page 28, measured from left border 74 to right border 78, is even slightly less than the width of third page 26, The width of fifth page 30, measured from left border 82 to outer border 86, is approximately equal to the width of fourth page 28 plus width 112 plus width 124.

Preferably, the pages 22, 24, 26, 28, and 30 have the following dimensions:
First page 22: 5.875 in wide
Second page 24: 5.875 in wide
Third page 26: 5.750 in wide
Fourth page 28: 5.125 in wide
Fifth page 30: 6.500 in wide

When assembled, first fold line 32 and second fold line 34 are folded into printed first side 90. Third fold line 36 and fourth fold line 38 are folded away from printed first side 90. First half-fold line 114 and third half-fold line 118 are co-linear and therefor form a partial fold line 136. Partial fold line 136 is folded into printed first side 90. Second half-fold line 116 and fourth half-fold line 120 are co-linear and therefor form a partial fold line 138. Partial fold line 138 is folded away from printed first side 90. Please note that partial fold lines 136, 138 do not extend into display area 102 and folding partial fold lines 136, 138 does not cause any folding in display area 102.

Fifth fold line 122 is preferably folded away from printed first side 90 but can alternatively be folded into first side 90.

Fifth page 30 has a seal portion 130 on opposite side 92. Seal portion 130 is defined by fourth fold line 38, upper border 84, first half-fold line 114, first die cut 104, third half-fold line 118, and lower border 88. Unsealed portion 132 of fifth page 30 is defined by outer border 86, lower border 88, fourth half-fold line 120, die cut 106, second half-fold line 116, and upper border 84.

Adhesive applied to at least one of seal area 130 or to a corresponding area on fourth page 28 causes fourth page 28 and fifth page 30 to adhere to each other.

Adhesive is also applied to tab 126 to cause tab 126 to adhere to opposite side 92 of third page 26. Preferably, fifth fold line 122 is folded away from printed first side 90 and top side 90 of tab 126 adheres to third page 26. In another embodiment, fifth fold line 122 is folded into printed first side 90 and opposite side 92 of tab 126 adheres to third page 26.

Format 20 with upraised portion 42 in an upraised position is shown in FIGS. 1 and 2. FIG. 1 is shown partially disassembled for clarity only.) Note that display area 102 extends through aperture 100. Unsealed portion 132 is spaced apart from fourth page 28 by width 112.

The system for manufacturing the format 20 will now be described. A web 200 is mounted on a web press 202. Web 200 has a first side 204 and a second side 206. Preferably, both sides 204, 206 are printed, although the printer may print only first side 204. After printing, web 200 is preferably slit into a number of ribbons 208a, 208b, etc., as the total width of format 20 is likely much less than the width of web 200. Each ribbon 208 can be processed thereafter in an identical manner, so the method will be described with respect to a single ribbon 208, with the understanding that web press 202 may be performing identical operations on a plurality of ribbons 208a, 208b, etc. Different ribbons can also be processed in different ways, however, as is known in the art. For example, one ribbon may become the format 20 of the present invention and another ribbon may become an envelope.

Printed ribbon 208 has the width of five pages 22, 24, 26, 28, and 30, as described above. Ribbon 208 passes through a die cutter 210. Die cutter 210 cuts aperture 100 and die cuts 104, 106 in pages 28 and 30 of ribbon 208. Die cuts 104, 106 are in vertical registry with aperture 100 along the length of web 200. Preferably, a single die cutter 210 cuts both aperture 100 and die cuts 104, 106 at the same time, but separate die cutters can be used if desired.

Die cutter 210 also preferably simultaneously applies perforations at partial fold lines 136, 138. A separate die cutter can be used to apply these perforations if desired.

Ribbon 208 next proceeds to first plow station 212, Plow station 212 applies a Z-fold by folding ribbon 208 at fold line 38 and, at the same time, reverse folding first half-fold line 114 and third half-fold line 118. Since first half-fold line 114 and third half-fold line 118 do not extend through display area 102, display area 102 is not folded and, after folding, is in registry with aperture 100. A portion of ribbon 208 as it exists at this point in the method and as seen from opposite side 92 is shown in FIG. 4.

Ribbon 208 proceeds to second plow station 214, which folds ribbon 208 at second half-fold line 116 and fourth half-fold line 120. Since second half-fold line 116 and fourth half-fold line 120 do not extend through display area 102, display area 102 is not folded at this step either and remains in registry with aperture 100. A portion of ribbon 208 as it exists at this point in the method is show in FIG. 5.

Ribbon 208 proceeds to glue station 220, which applies adhesive to tab 126. Alternatively, glue station 220 can apply adhesive to the corresponding area of ribbon 208 immediately adjacent tab 126. This corresponding area preferably as the same width as tab 126.

Ribbon 208 next proceeds to third plow station 222, which applies third fold line 36 and folds ribbon 208 over onto itself, causing tab 126 to adhere to third page 26.

Fourth plow station 224 applies second fold line 34 and folds ribbon 208 onto itself Fifth plow station 226 applies first fold line 36 and folds ribbon 208 onto itself again. Ribbon 208 then proceeds to rotary cutter 228, which transversely cuts ribbon 208 to complete manufacture of format 20.

The method of manufacture of format 20 is:
302 Provide a web on a web press
304 Print the web on at least one side
306 Cut an aperture in the web.
308 Apply a pair of die cuts to form a display area in vertical registry with the aperture.
310 Apply a Z-fold to fold the web onto itself at a fold line and reverse fold the web back onto itself at a second a second fold line, the second fold line intersecting the first borders of each of the first connection portion and the second connection portion.
312 Fold a tab and glue the tab to the lower ribbon; and
316 Transversely cut the web

Please note that the steps need not always he performed in the preferred order.

Other ribbons slit from web 200 can be formed into other formats to which format 20 is married, or formed into envelopes into which format 20 is placed, or have other finishing operations applied in manners known in the art. Format 20 can be personalized for mailing to individuals by printing names, addresses, and mailing bar codes on format 20 in manners known in the art. Other finishing operations can he performed on ribbon 208 at any step in the process, including but not limited to aqueous coating, overall and spot UV coatings, film lamination, embossing, foil and hologram stamping, and post embossing.

While preferred embodiments of the present invention are shown and described, it is envisioned that those skilled in the art may devise various modifications of the present invention without departing from the spirit and scope of the appended claims.

We claim:

1. A method of manufacturing an advertising format, comprising the steps of:
providing a web on a web press, the web having a first edge and a second edge and a top side and bottom side;
cutting an aperture in the web;
forming a display area in vertical registry with the aperture, the display area defined by a first die cut, a second die cut, a first connection portion, and a second connection portion, the first die cut being proximal to the aperture and the second die cut being distal to the aperture, each of the die cuts having a first end and a second end, the first die cut first end being separated from the second die cut first end by the first connection portion and the first die cut second end being separated from the second die cut second end by the second connection portion, the first connection portion having a width and the second connection portion having a width, the first connection portion width being the same as the second connection portion width, and the display area having a shape configured to fit completely within the aperture;
forming four perforation lines in the web,
the first perforation line being between the aperture and the first die cut;
the second perforation line being a first partial fold line, the first partial fold line intersecting the first end of the first die cut and the second end of the first die cut and being parallel to the first edge, the first partial fold line not being formed in the display area;
the third perforation line being a second partial fold line, the second partial fold line intersecting the first end of the second die cut and the second end of the second die cut and being parallel to first edge, the second partial fold line not being formed in the display area; and
the fourth perforation line being spaced from the second edge of the web by a distance substantially equal to the width of the first and second connection portions;
forming three fold lines in the web, the first fold line being between the aperture and the first edge of the web, the second fold line being the first fold line and the first edge of the web, and the third fold line being between the second fold line and the first edge of the web;
applying an adhesive to an area of the web between the first die cut and the aperture;
forming a Z-flap by folding the web at the first perforation line and the second perforation line so that the display area registers over the aperture;
folding the web onto itself at the third perforation line;
applying an adhesive to at least one of a first area defined by the fourth perforation line and the second edge of the web and a second area extending from first fold line toward the second fold line and spaced a distance substantially equal to the width of the first and second connection portions;
folding the web onto itself at the first fold line;
folding the web under itself at the second fold line; and
folding the web onto itself at the third fold line.
